(19) United States
(12) Patent Application Publication
(10) Pub. No.: US 2023/0024744 A1
(43) Pub. Date: Jan. 26, 2023

(54) METHOD AND SYSTEM FOR OPTIMIZING PROBLEM-SOLVING BASED ON PROBABILISTIC BIT CIRCUITS

(71) Applicant: Institute of Semiconductors, Chinese Academy of Sciences, Beijing (CN)

(72) Inventors: Kaiyou Wang, Beijing (CN); Xiukai Lan, Beijing (CN); Yucai Li, Beijing (CN); Yi Cao, Beijing (CN)

(73) Assignee: Institute of Semiconductors, Chinese Academy of Sciences, Beijing (CN)

(21) Appl. No.: 17/812,583

(22) Filed: Jul. 14, 2022

(30) Foreign Application Priority Data
Jul. 20, 2021 (CN) 202110821974.6

(51) Int. Cl. G06N 7/00

(52) U.S. Cl. CPC G06N 7/005

(57) ABSTRACT

A method and a system for optimizing problem-solving based on probabilistic bit circuits are provided. The method includes: performing a modeling transformation on an objective problem to obtain a corresponding Hamiltonian relationship; obtaining a column Hamiltonian of said probabilistic bit circuit based on said Hamiltonian relationship; and performing parallel annealing iterations on multicolumn Hamiltonian based on row-flipping operations on said probabilistic bit circuits to obtain an updated probabilistic bit configuration, so as to achieve optimization of said problem.

### CROSS-REFERENCE TO RELATED APPLICATION

This application claims the priority of Chinese Patent Application No. 202110821974.6 filed on Jul. 20, 2021 in the China National Intellectual Property Administration, the content of which is incorporated herein by reference in entirety.

### TECHNICAL FIELD

The present disclosure relates to a field of probabilistic computing technology, and specifically to a method and a system for optimizing problem-solving based on probabilistic bit circuits.

### BACKGROUND

In the related art, conventional digital computers can use pseudo-random numbers generated by deterministic algorithms to achieve solutions to search, optimization, sampling, and other problems. However, the pseudo-random numbers have defects such as periodicity, coherence, and uneven distribution of the generated large number, which cause the accuracy of the conventional digital computers for solving problems such as search, optimization, and sampling to be seriously affected, making it difficult to achieve accurate problem-solving. For this reason, there is a need to provide as an effective solution to achieve the exact solution of the above problems.

### SUMMARY

One aspect of the present disclosure provides a method for optimizing problem-solving based on probabilistic bit circuits, the method includes: performing a modeling transformation on an objective problem to obtain a corresponding Hamiltonian relationship; obtaining a column Hamiltonian of said probabilistic bit circuit based on said Hamiltonian relationship; and performing parallel annealing iterations on multicolumn Hamiltonian based on row-flipping operations on said probabilistic bit circuits to obtain an updated probabilistic bit configuration, so as to achieve optimization of said problem.

According to the embodiments of the present disclosure, in said obtaining said column Hamiltonian of said probabilistic bit circuit based on said Hamiltonian relationship, including: applying said Hamiltonian relationship to a plurality of columns of probabilistic bit cells of said probabilistic bit circuit, wherein said column Hamiltonian is a parallel annealed iterative branch of said Hamiltonian relationship.

According to the embodiments of the present disclosure, in said performing said modeling transformation on said objective problem to obtain said corresponding Hamiltonian relationship, including: transforming said objective problem into an objective mathematical problem through modeling transformation; mapping nodes of said objective mathematical problem to columns of probabilistic bit cells of said probabilistic bit circuit, and determining said column Hamiltonian based on a predetermined Hamiltonian relationship and a configuration of said columns of probabilistic bit cells; and determining interdependencies between said probabilistic bit cells in said probabilistic bit cell column based on said Hamiltonian relationship.

According to the embodiments of the present disclosure, in said performing parallel annealing iterations on said multicolumn Hamiltonian based on row-flipping operations on said probabilistic bit circuits to obtain an updated probabilistic bit configuration, including: initializing an array of probabilistic bit circuits based on a row-flipping operation on said probabilistic bit circuits to read an initial state of probabilistic bit cell prior to the start of the annealing iteration; determining a configuration corresponding to a column Hamiltonian with the smallest value among parallel column Hamiltonian; and performing a parallel annealing iteration on said probabilistic bit circuit for said configuration.

According to the embodiments of the present disclosure, in said initializing said array of probabilistic bit circuits based on a row-flipping operation on said probabilistic bit circuits, including: performing a row-flipping operation with 50% probability on said array of probabilistic bit circuits, wherein said array of probabilistic bit circuits is an array of probabilistic bit cells based on spin-orbit torque devices.

According to the embodiments of the present disclosure, in said performing said parallel annealing iteration on said probabilistic bit circuit for said configuration, including: determining a row writing probability corresponding to said configuration based on an interdependence between said configuration corresponding to the column Hamiltonian with the smallest value and a column of said probabilistic bit cell; and sequentially performing, based on the row-flipping operation of said probabilistic bit circuit, a write operation to rows of probabilistic bit cells of said probabilistic bit circuit according to said row write probability, so as to iterate over a configuration of corresponding columns of probabilistic bit cells.

According to the embodiments of the present disclosure, the method further includes: reading an updated state of probabilistic bit cell in said array of the probabilistic bit circuits after each of said parallel annealing iterations; and determining an updated column Hamiltonian based on said updated state of probabilistic bit cell.

According to the embodiments of the present disclosure, wherein performing a parallel annealing iteration on said column Hamiltonian to determine probabilistic bit configuration, including: determining a probabilistic bit configuration corresponding to said updated column Hamiltonian when a minimum value of said updated column Hamiltonian is either a fixed value or fluctuant in a very small range; and performing parallel annealing iterations on said updated column Hamiltonian when the minimum value of said updated column Hamiltonian is neither a fixed value nor fluctuant in a very small range.

Another aspect of the present disclosure provides a system for optimizing problem-solving based on probabilistic bit circuits, which is applied to implement the above method, including: probabilistic bit circuits for parallel probabilistic operations; a multiplexer for outputting a plurality of signals read from said probabilistic bit circuits; an analog-to-digital converter for converting a plurality of signals from the output of said multiplexer to digital signals; a processor for processing the digital signal converted by said analog-to-digital converter to determine a column Hamiltonian, and for determining a flipping probability value of said row probability bits corresponding to said column Hamiltonian; a digital-to-analog converter for converting the flipping probability value obtained by said processor into an analog signal; and a demultiplexer for following up the analog signal converted by said digital-to-analog converter for probabilistic bit reading and writing operations.

According to the embodiments of the present disclosure, said probabilistic bit circuit includes a plurality of probabilistic bit cells and a plurality of control lines, each of said plurality of probabilistic bit cells includes a spin-orbit torque magnetic tunnel junction for magnetization flipping when said plurality of control lines are applied with different voltages or currents.

### BRIEF DESCRIPTION OF THE DRAWINGS

FIG. 1 schematically illustrates a flowchart of a method for optimizing problem-solving based on probabilistic bit circuits according to the embodiments of the present disclosure; and

FIG. 2 schematically illustrates an application flowchart of a method for optimizing problem-solving based on probabilistic bit circuits according to the embodiments of the present disclosure; and

FIG. 3 schematically illustrates a composition diagram of a probabilistic bit circuit according to the embodiments of the present disclosure; and

FIG. 4 schematically illustrates a composition diagram of a probabilistic bit cell according to the embodiments of the present disclosure; and

FIG. 5 schematically illustrates a composition diagram of a system for optimizing problem-solving based on probabilistic bit circuits according to the embodiments of the present disclosure.

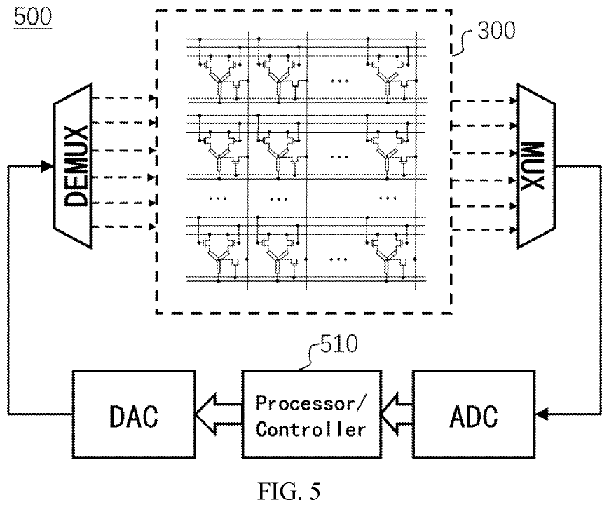

### DETAILED DESCRIPTION OF EMBODIMENTS

In order to make the purpose, technical solutions and advantages of the present disclosure more clearly understood, the following is a further detailed description of the present disclosure in conjunction with specific embodiments and with reference to the accompanying drawings.

It should be noted that the implementations not illustrated or described in the accompanying drawings or in the body of the specification are in a form known to those of ordinary skill in the art to which they belong and are not described in detail. Furthermore, the above definitions of the various components and methods are not limited to the various specific structures, shapes or ways mentioned in the embodiments, which may be simply changed or replaced by those of ordinary skill in the art.

It should also be noted that the directional terms mentioned in the embodiments, such as “up”, “down”, “front”, “back ”, “left”, “right”, etc., are merely directions with reference to the accompanying drawings and are not intended to limit the scope of protection of the present disclosure. Throughout the accompanying drawings, identical elements are indicated by the same or similar accompanying marks. Conventional structures or constructions will be omitted where this may lead to confusion in understanding the present disclosure.

The shapes and dimensions of the components in the drawings do not reflect true size and scale, but are merely illustrative of embodiments of the present disclosure. In addition, any reference symbols located between the brackets in the claims should not be constructed to limit the claims.

Further, the word “including” does not exclude the existence of an element or step not listed in the claim. The word “one” or “one” before the element does not exclude the existence of multiple such elements.

The use of ordinal numbers such as “first”, “second”, “third”, etc. in the specification and claims to modify the corresponding components does not in itself imply that the components have Any order, nor does it represent the order of a component and another component or the order of the manufacturing method, the use of these sequences is only used to enable a component with a certain name and another component with the same name may make a clear distinction.

Those skilled in the art will appreciate that the modules in the apparatus of an embodiment may be adaptively changed and set in one or more apparatuses different from the embodiment. The modules or units or components of an embodiment may be combined into a single module or unit or component, and in addition they may be divided into a plurality of sub-modules or sub-units or sub-components. Except that at least some of such features and/or processes or units are mutually exclusive, any combination of all features disclosed in this specification (including the accompanying claims, summary and accompanying drawings) and all processes or units of any method or apparatus may be employed. Unless otherwise expressly stated, each feature disclosed in this specification (including the accompanying claims, abstracts, and accompanying drawings) may be replaced by a substitute feature providing the same, equivalent, or similar purpose. And, in unit claims where several devices are enumerated, several of these devices may be specifically embodied by the same hardware item.

Similarly, it should be understood that in order to streamline the present disclosure and to aid in understanding one or more of the various aspects of the disclosure, in the above description of exemplary embodiments of the present disclosure, the various features of the present disclosure are sometimes grouped together in a single embodiment, figure, or description thereof. However, the methods of the disclosure should not be construed to reflect the intent that the claimed protection of the present disclosure requires more features than those expressly set forth in each claim. More precisely, as reflected in the claims below, the disclosure aspect lies in fewer than all of the features of the individual embodiments disclosed previously. Accordingly, the claims that follow a specific embodiment are thereby expressly incorporated into that specific embodiment, wherein each claim is itself treated as a separate embodiment of the present disclosure.

In order to solve the technical problems in the related art that is difficult to achieve accurate problem-solving using conventional digital computers, the present disclosure provides a method and a system for optimizing problem-solving based on probabilistic bit circuits, with a view to achieving optimization of problem-solving and achieving the effect of solving problems more accurately.

One aspect of the present disclosure provides a method for optimizing problem-solving based on probabilistic bit circuits, which includes step S101 to step S103.

In step S101, a modeling transformation is performed on an objective problem to obtain a corresponding Hamiltonian relationship.

In step S102, a column Hamiltonian of the probabilistic bit circuit is obtained based on the Hamiltonian relation.

In step S103, parallel annealing iterations are performed on multicolumn Hamiltonian based on row-flipping operations on the probabilistic bit circuits to obtain an updated probabilistic bit configuration, so as to achieve optimization of said problem.

In embodiments of the present disclosure, the objective problem may be a practical problem requiring fast solution such as a combinatorial optimization problem or a reverse computation problem, where the combinatorial optimization problem includes problems such as travel quotient problem, maximum cut/minimum cut problem, graph coloring problem, knapsack problem, vertex coverage problem, minimum spanning tree, etc., and the reverse computation problem includes integer factorization, Boolean satisfiability problem, reversible logic problems.

In order to convert the above objective problem into a mathematical problem that the processor may handle operation, a modeling transformation operation is performed on the above objective problem, so that a Hamiltonian relationship is determined based on this objective problem corresponding to the mathematical problem. The Hamiltonian relationship is the correspondence between the node states of the mathematical problem and the Hamiltonian of the array of the probabilistic bit circuits.

Based on the Hamiltonian relationship, the column Hamiltonian may be annealed iteratively based on the probabilistic flipping property embodied by the flipping operation for the probabilistic bit circuit.

The probabilistic bit circuit is a circuit formed by an array of probabilistic bit cells implemented based on the device cells (i.e., probabilistic bit cells) of a spin micro-nano device. Spin micro-nano devices generate true random numbers using the randomness of the intrinsic magnetic flip of the device, without the above-mentioned defects of pseudo-random numbers such as periodicity, coherence, and uneven distribution of the generated large number. Among them, Spin-orbit Torque (SOT) devices, as one of the typical spin micro-nano devices, have the advantages of high speed, low power consumption, high endurance and good stability, and their deterministic magnetic flip may be used to implement logic storage functions. However, there does not any application of SOT devices in the field of probabilistic computing technology for their probabilistic flipping property. In addition, the random memory of conventional digital computers is implemented with electric charge or current to data storage, and the data will be lost after power failure; while spin micro-nano devices use magnetic storage of data with non-volatility.

By performing parallel annealing iterations on the column Hamiltonian of the column cells determined according to the probabilistic bit circuit, the updated probabilistic bit configuration corresponding to the probabilistic bit circuit may be obtained. In this case, the probabilistic bit configuration is the final solution of the above objective problem. The parallel annealing iteration for the probabilistic bit circuit may continuously reduce the Hamiltonian, so that the optimal solution of the problem may be obtained or approached, thereby making the whole problem-solving process faster and more efficient.

Therefore, compared to the problem-solving by conventional digital computers in the related art, the method of the present embodiment achieves a large-scale operation of parallel probabilistic annealing processing by flipping operations based on the probabilistic bit circuit, thus optimizing the problem-solving process and making the solution more accurate, faster and more applicable to a wider range of problem-solving.

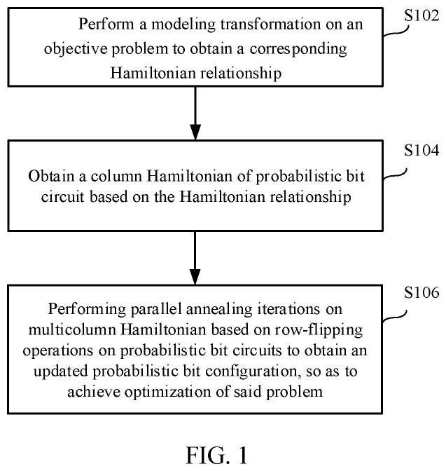

As shown in FIG. 1, according to embodiments of the present disclosure, in step S101, the modeling transformation is performed on the objective problem to obtain the corresponding Hamiltonian relationship, which includes the follows steps.

The objective problem is converted into an objective mathematical problem through the modeling transformation.

The nodes of the objective mathematical problem are mapped to the columns of the probabilistic bit cells of the probabilistic bit circuit, and the column Hamiltonian is determined based on the predetermined Hamiltonian relationship and the configuration of the columns of the probabilistic bit cells.

The interdependences between the probabilistic bit cells in the columns of the probabilistic bit cells are determined based on the Hamiltonian relation.

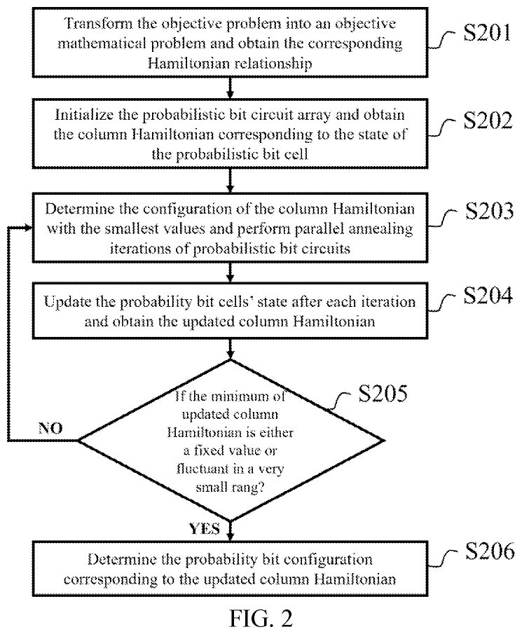

As shown in the FIG. 2, in step S201, an actual problem (i.e., the objective problem) is modeled and transformed into a mathematical problem (i.e., the objective mathematical problem) before running the annealing algorithm.

After that, according to the predefined Hamiltonian relation H(x₁, x₂, . . . , x_{M}) associated with the corresponding nodes x₁, x₂, . . . , x_{M} of the objective mathematical problem, the nodes are mapped to each column of probabilistic bit cells (i.e., p-bit cells, such as m₁ⱼ, m₂ⱼ, . . . , m_{Mj}, j=1, 2, . . . , N) in the array of the probabilistic bit circuits. The configuration {m₁ⱼ, m₂ⱼ, . . . , m_{Mj}} of each column of p-bit cells (i.e., columns of probabilistic bit cells) representing a set of alternative solutions to the problem, and the column Hamiltonian H(m₁ⱼ, m₂ⱼ, . . . , m_{Mj}) is determined based on the above Hamiltonian relationship and the configuration of the columns of probabilistic bit cells.

Therefore, after mapping the nodes of the objective mathematical problem to the p-bit cell array, the p-bit cell array may be used to solve the above objective mathematical problem. The state mᵢ of the mapped p-bit cell is the state xᵢ of the node, and the state of the node of the objective mathematical problem may be updated by writing to the p-bit cell.

Among them, different objective problems have different Hamiltonian relationship. For example, for the maximum cut problem (Max-Cut) with M vertices, a set of M nodes is needed to map into each column of p-bit cells:

$${H}_{Max - Cut} = - \frac{1}{2} {\sum }_{i < j} {W}_{i j} ( 1 - {y}_{i} {y}_{j} ) , \qquad ( 1 )$$

where yᵢ=2xᵢ−1 and M nodes x₁, x₂, . . . , x_{M} correspond to M p-bit cells per cell column (or x₁ corresponds to the first row m₁ⱼ of the array, x₂ corresponds to the second row m₂ⱼ of the array, and so on).

Further, for the Travelling Salesman Problem (TSP) with m cities, a set of M=m² nodes are required to map into each column p-bit:

H_{TSP}=AΣᵥ₌₁^{m}(1−Σ=ⱼ₌₁^{m}x_{v,j})²+AΣⱼ₌₁^{m}(1−Σᵥ₌₁^{m}x_{v,j})²+BΣ_{u<v,j}Wᵤᵥx_{u,j}x_{v,j+1} (2)

where xᵥⱼ represents M nodes, x₁₁ corresponds to the first row m₁ⱼ of the array, x₁₂ corresponds to the second row m₂ⱼ of the array, and so on.

It may be seen that Wᵢⱼ and Wᵤᵥ, appearing in equations (1) and (2) above are the matrix elements of the weight matrix, and A and B are the coefficients.

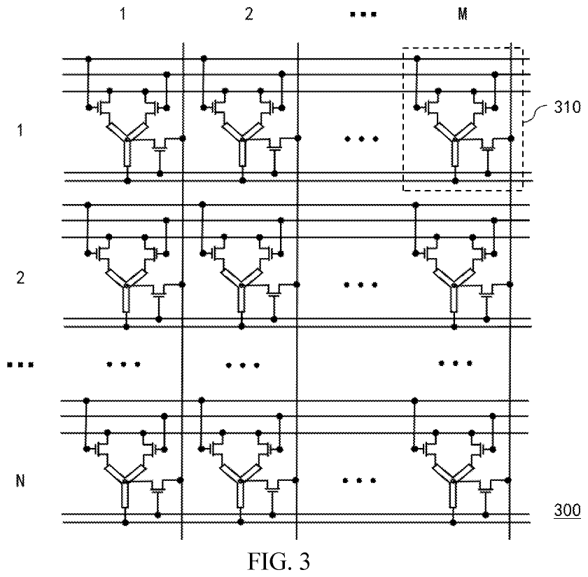

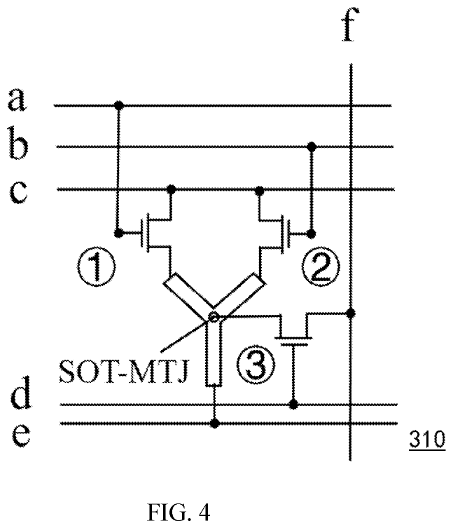

As shown in the FIG. 3 and FIG. 4, the probabilistic bit circuit consists of several basic cells arranged and connected, each of the basic cells is a basic probabilistic bit cell 310, i.e., a p-bit cell. The probabilistic bit cell 310 consists of three transistors \textcircled{1}-\textcircled{3} and one spin-orbit torque magnetic tunnel junction SOT-MTJ. In addition, the transistors 310 of the probabilistic bit cell and the spin-orbit torque magnetic tunnel junction SOT-MTJ are connected by multiple parallel or perpendicular circuit connections a-f, as follows:

connection a, connected to the gate of transistor \textcircled{1}, for controlling the gate voltage input of transistor \textcircled{1};

connection b, connected to the gate of transistor \textcircled{2}, for controlling the gate voltage input of transistor \textcircled{2};

connection line c, connected to the source of transistor \textcircled{1} and transistor \textcircled{2}, respectively, for controlling the source voltage input of transistor \textcircled{1} and transistor \textcircled{2};

connection d, connected to the gate of transistor \textcircled{3}, for controlling the gate voltage input of transistor \textcircled{3};

connection e, connecting the above transistor \textcircled{3} and the ground terminal of the spin-orbit torque magnetic tunnel junction SOT-MTJ to achieve deviceground;

connection line f, connected to the source of transistor \textcircled{3}, and is used to control the source voltage input of transistor \textcircled{3}.

In the solid structure, the connecting lines a-e may be parallel to each other, and the connecting line f may be perpendicular to either of the connecting lines a-e.

In addition, the spin-orbit torque magnetic tunnel junction SOT-MTJ includes at least one input and at least one ground terminal, and applying a voltage pulse to each input regulates the current density gradient of the patterning electrodes, and the current density gradient is used to determine the magnetization flip probability of the spin-orbit torque magnetic tunnel junction SOT-MTJ.

In the spin-orbit torque magnetic tunnel junction SOT-MTJ of the embodiment of the present disclosure, a reference layer and a free layer are included, wherein the reference layer and the free layer each contain at least one ferromagnetic layer, and the material of the ferromagnetic layer may be at least one of a ferromagnetic material such as Co, CoFeB, etc. The reference layer and the free layer further include an insulating layer, and the material of the insulating layer may be at least one of the insulator materials such as MgO, AlO₂₃, BN, etc. Wherein, the reference layer is located at the top layer of the device structure. The magnetization direction of the reference layer of the top layer is fixed using an artificial antiferromagnetic structure or an exchange bias effect of the antiferromagnetic layer, while the ferromagnetic layer of the bottom layer is a free layer, and the magnetization direction of the free layer may be regulated by the current of the heavy metal layer of the bottom layer. Wherein, the heavy metal layer is a graphical electrode in the spin-orbit torque device of the embodiments of the present disclosure and is provided on the surface of the free layer of the device.

In this embodiment of the disclosure, the magnetization direction flip probability refers to a statistical result such as approximately 50000 flip to state “1” in a single tunnel junction if a synchronization pulse is applied to that tunnel junction up 100000 to several times when the input voltages V_{A}=10 V and V_{B}=5 V are applied to at least two inputs of the spin-orbit torque magnetic tunnel junction SOT-MTJ. Similarly, if a synchronization pulse is applied once to 100000 each of the same spin-orbit torque magnetic tunnel junctions SOT-MTJ at voltages V_{A}=10 V and V_{B}=5 V, approximately 50000 spin-orbit torque magnetic tunnel junction SOT-MTJ will have state “1”. where V_{A} and V_{B} may be understood as the input voltage pulses at the input of the above spin-orbit torque magnetic tunnel junction SOT-MTJ.

Therefore, when the probabilistic bit cell of the embodiment of the present disclosure is manipulated, transistor \textcircled{1} and transistor \textcircled{2} are turned on so that the current at the input may enter the probabilistic bit cell. Since the bottom electrode (i.e., spin-orbit torque magnetic tunnel junction SOT-MTJ) is a Y-shaped structure, changing the relative current input magnitude of transistor \textcircled{1} and transistor \textcircled{2} adjusts the magnitude of the current density gradient at the center, and thus controls the probability of the free layer magnetization flip. For example, if the input current of transistor \textcircled{1} Iᵢ5 mA and the input current of transistor \textcircled{2} I₂=1˜10 mA, the current density at the left and right sides of the center appears to be different and the current density gradient satisfies

$$\frac{{dJ}_{x}}{dx} ∝ ( {I}_{2} - {I}_{1} ) .$$

When rearing, turn on transistor \textcircled{3}, when the magnetization direction of the two magnetic layers is the same, the tunnel junction is a low resistance state, representing “0”, while when the magnetization direction of the two magnetic layers is opposite, the tunnel junction is a high resistance state, representing “1”.

Therefore, based on the above spin-orbit torque magnetic tunnel junction SOT-MTJ of the present disclosure, the regulation of probabilistic bits may be achieved by controlling the current density gradient within the tunnel junction surface, which provides a controllable solution for probability calculation with high speed, low power consumption, small size, and non-volatility.

As shown in the FIGS. 3 and 4, M×N spin-orbit torque probabilistic bit cells 310 modulated by the in-plane current density gradient are formed into a cell array and connected into the probabilistic bit circuit described above. The features of this circuit include the followings.

(1) Since the transistors \textcircled{1} and transistors \textcircled{2} of each row of p-bit cells 310 (mᵢ₁, mᵢ₂, . . . , m_{iN}, i=1, 2, . . . , M) and the ground terminal are connected in parallel through the circuit, the writing electrical signals 310 of each row of p-bit cells are the same, i.e., each row of p-bit cells 310 will be written simultaneously with the same probability of writing.

(2) The gates 310 of transistors \textcircled{3} of different p-bit cells are connected to each other in a circuit in parallel, while the sources are connected vertically, so that the separate reading of p-bit cells 310 may be controlled (because the transistors must be energized at the same time when the gates and sources are energized in order to be turned on, assuming that the p-bit cell mᵢⱼ needs to be read, only the corresponding circuits in row i and column j need to be energized, and the other circuits are not energized, at which time only the gate of transistor \textcircled{3} of mᵢⱼ bias voltage between the gate and the source is turned on).

As shown in FIG. 1, in step S102 of obtaining a column Hamiltonian of a probabilistic bit circuit based on a Hamiltonian relation, according to embodiments of the present disclosure, including.

The Hamiltonian relationship is applied to a plurality of columns of probabilistic bit cells of a probabilistic bit circuit, where the column Hamiltonian is a parallel annealing iterative branch of the Hamiltonian relationship.

In an M×N array of p-bit cells as shown in the FIG. 3, each column of p-bit cells (m₁ⱼ, m₂ⱼ, . . . , m_{Mj}, j=1, 2, . . . , N) of the configuration {m₁ⱼ, m₂ⱼ, . . . , m_{Mj}} represents a solution of the problem, and since the p-bit writing probability of each row is the same, the results of N columns after the same iteration may be considered as this N parallel computations of this iteration. Therefore, compared to the previous methods in which only one parallel computation is performed in each iteration, the above problem-solving optimization method in the present disclosure embodiment may realize N parallel computations in one iteration using the circuit, achieving a convergence speedup of up to N times and making the whole problem-solving process faster.

According to embodiments of the present disclosure, in step S103 parallel annealing iteration of a multicolumn Hamiltonian based on a row-flipping operation on a probabilistic bit circuit to obtain an updated probabilistic bit configuration to achieve problem-solving optimization, including:

initializing an array of probabilistic bit circuits based on a flipping operation on the probabilistic bit circuits to read the probabilistic bit cell state before the start of the annealing iteration;

determining a configuration corresponding to a column Hamiltonian with the smallest value among parallel column Hamiltonian; and

performing a parallel annealing iteration on the probabilistic bit circuit for the configuration.

According to embodiments of the present disclosure, in initializing an array of probabilistic bit circuits based on a flipping operation on the probabilistic bit circuits, including: performing a flipping operation on the array of probabilistic bit circuits with 50% probability, wherein the array of probabilistic bit circuits is an array of probabilistic bit cells based on spin-orbit torque devices.

As shown in FIG. 2, in step S202, the probabilistic bit circuit is an array composed of probabilistic bit cells based on the spin-orbit torque devices described above, and the entire probabilistic bit circuit needs to be initialized with the array before the annealing iterative process of the probabilistic bit circuit is performed to improve the solution accuracy of the annealing algorithm.

The array is initialized by performing a 50% probability flipping operation on the probabilistic bit cell followed by the entire M×N array, and the state of each p-bit cell in the array is read at this time (i.e., the initial probabilistic bit cell state). After the array is initialized, the read probabilistic bit cell state is used to determine the amount of Hamiltonian (i.e., the column Hamiltonian) corresponding to each p-bit cell in the probabilistic bit circuit, based on the aforementioned Hamiltonian relationship.

As previously mentioned, in step S202, the probabilistic bit cell states of all p-bit cells in the array of the above probabilistic bit cell circuit are read, and the Hamiltonian Hⱼ(m₁ⱼ, m₂ⱼ, . . . , m_{Mj}) corresponding to the p-bit cell configuration of each column is obtained separately, i.e., the column Hamiltonian.

As shown in FIG. 2, in steps S203-S205, based on the column Hamiltonian Hⱼ(m₁ⱼ, m₂ⱼ, . . . , m_{Mj}) described above, the configuration of probabilistic bit cell columns with the smallest column Hamiltonian value among them (e.g., the ath column m₁ₐ, m₂ₐ, . . . , m_{Ma}) may be filtered to execute the annealing algorithm to start the iterative process.

Wherein, in an M×N array of p-bit cells as shown in the FIG. 3, each column of p-bit cells (m₁ⱼ, m₂ⱼ, . . . , m_{Mj}, j=1, 2, . . . , N) of the configuration {m₁ⱼ, m₂ⱼ, . . . , m_{Mj}} represents a solution of the problem, and since the p-bit writing probability of each row is the same, the results of the N columns after the same iteration may be considered as N parallel calculations of this iteration.

Therefore, compared to previous methods in which only one parallel computation is performed at each iteration, the above problem-solving optimization method in the present disclosure embodiment may realize N parallel computations in one iteration using a circuit to achieve up to N times convergence speedup, making the whole problem-solving process faster.

According to embodiments of the present disclosure, in performing parallel annealing iteration on a probabilistic bit circuit for the configuration, including:

determining a row writing probability corresponding to the configuration based on an interdependence between the configuration corresponding to the column Hamiltonian with the smallest value and a column of probabilistic bit cell; and

sequentially performing a write operation to rows of probabilistic bit cells of the probabilistic bit circuit based on the row write probability based on the row-flipping operation of the probabilistic bit circuit, so as to iterate over the configuration of corresponding columns of probabilistic bit cells.

As shown in FIG. 2, in steps S203-S205, a number of rows in the array of probabilistic bit circuits are selected, and the partial derivatives of the Hamiltonian are calculated using the configuration {m₁ₐ, m₂ₐ, . . . , m_{Ma}} of the p-bit cells in the ath column

$${θ}_{i a} = \frac{\partial {H}_{a} ( {m}_{1 a} , {m}_{2 a} , … , {m}_{M a} )}{\partial {m}_{i a}} ,$$

thus obtaining the dependence between the corresponding p-bit cells Iᵢₐ=−I₀θᵢₐ, where I₀>0 is the dependence strength coefficient.

According to the above dependencies, the write probability of p-bit cells per row may be obtained Pᵢ∝Iᵢₐ. The probability of writing a p-bit cell per row, i.e., the probability of writing a row.

Based on the calculated row writing probability, each p-bit cell is written in turn, in any order. Among them, due to the limitation of asynchronous update, the number of rows of cells written simultaneously is less than M rows. In addition, during the row writing operation, the configuration {m₁ₐ′, m₂ₐ′, . . . , m_{Ma}′} of the p-bit cell in ath column need to be read immediately after each writing, and the writing probability of the other updated row p-bit cells

$${P}_{j} ∝ - \frac{\partial {H}_{a}^{′} ( {m}_{1 a}^{′} , {m}_{2 a}^{′} , … , {m}_{Ma}^{′} )}{\partial {m}_{ja}^{′}}$$

is redetermined until all M rows are written once. At this point, one iteration ends.

In the embodiment of the present disclosure, synchronous update means that M rows may be written at the same time, and asynchronous update means that M row p-bits are written in at least two parts, with writings of each iteration in random rows and order, but the probability of the second update is obtained using the state of the p-bit cell after the first update. For example, each iteration performs two asynchronous updates, the first one writes a random half of rows. The probability of writing

$${P}_{i} ∝ - \frac{\partial {H}_{a} ( {m}_{1 a} , {m}_{2 a} , … , {m}_{Ma} )}{\partial {m}_{ia}}$$

is calculated using the column cell state of the smallest column of the Hamiltonian in the previous iteration. The second time the remaining rows are written, the write probability

$${P}_{j} ∝ - \frac{\partial {H}_{a}^{′} ( {m}_{1 a}^{′} , {m}_{2 a}^{′} , … , {m}_{Ma}^{′} )}{\partial {m}_{ja}^{′}}$$

is calculated using the current configuration of the same column.

According to embodiments of the present disclosure, the method further includes:

reading the updated state of probabilistic bit cell in the probabilistic bit circuit array after each iteration in the parallel annealing iterative process;

determining the updated column Hamiltonian based on the update state of probabilistic bit cell.

As shown in FIG. 2, in steps S203-S205, after each annealing iteration is completed, as previously described, the probabilistic bit cell state of the probabilistic bit circuit array after iteration during such annealing iteration as previously described is read, and the probabilistic bit cell state is used as the updated probabilistic bit cell state, i.e., the new configuration. A new column Hamiltonian corresponding to the probabilistic bit cell of each column, i.e., the updated column Hamiltonian, is obtained based on this updated probabilistic bit cell state as in the similar operation of the preceding step S102. Finally, based on this updated column Hamiltonian, it is determined whether to continue the next iteration process or to directly output the probabilistic bit configuration corresponding to the above updated column Hamiltonian as the solution result.

As shown in FIG. 1, in step S103 of parallel annealing iteration of column Hamiltonian to determine probabilistic bit configuration, according to embodiments of the present disclosure, including:

determining the probabilistic bit configuration corresponding to the updated column Hamiltonian when the minimum value of the updated column Hamiltonian is a fixed or fluctuating value;

performing parallel annealing iterations on the updated column Hamiltonian when the minimum value of the updated column Hamiltonian is a non-fixed or non-volatile value.

As shown in FIG. 2, in step S205, if the minimum value of the updated column Hamiltonian after multiple iterations is a fixed or fluctuating value, it means that the updated column Hamiltonian corresponds to the probabilistic bit configuration as a satisfactory optimization result. On the contrary, it means that the updated column Hamiltonian corresponds to the probabilistic bit configuration is an unsatisfactory optimization result. In this case, to determine whether the satisfactory optimization result is achieved, it is necessary to determine whether the updated column Hamiltonian with the smallest value obtained after at least one annealing iteration process reaches the lowest value constant (i.e., fixed value) or fluctuates within a small range (i.e., fluctuating value).

When the optimization result is satisfactory, it means that the probabilistic bit configuration corresponding to the updated column Hamiltonian belongs to the solution result required by the problem-solving optimization method of the embodiment of the present disclosure. Otherwise, it is necessary to give that updated column Hamiltonian to re-perform step S203 and continue the iterative process of annealing in a loop until a satisfactory optimization result is achieved.

In addition, the best result (i.e., the result with the lowest Hamiltonian) may not appear in the last iteration after the solution is finished, such 100 iterations, and the result with the lowest Hamiltonian may appear at the 98^{th} iteration.

As shown in the FIG. 2, in step S206, in the case of satisfactory optimization results, the probabilistic bit configuration corresponding to the lowest historical column Hamiltonian in this solution process is ended and recorded, and this configuration is the final result of this optimization method for solving the problem.

Therefore, the above-mentioned probabilistic bit circuit-based problem-solving optimization method of the present disclosure embodiment redesigns a fully electronically controlled spin-orbit torque probabilistic bit circuit that may run a massively parallel probabilistic annealing algorithm based on the probabilistic flip-flop characteristics of the spin-orbit torque device, which may achieve up to N times the convergence speed of the Hamiltonian and a faster solving process. Compared with the case in the prior art where multiple solutions are sometimes required to obtain the optimal result of a problem due to the stochastic nature of the annealing algorithm, the above method of the present disclosure embodiment may achieve N times parallel solution using the massively parallel probabilistic annealing circuit, thus increasing the chances of solving the optimal result and making the solution result more accurate and effective.

In addition, the above method of the embodiment of the present disclosure may be applied to quickly solve combinatorial optimization problems such as travel quotient problems, maximum cut/minimum cut problems, graph coloring problems, knapsack problems, vertex coverage problems, minimum spanning trees, etc., and to quickly solve integer factorization, Boolean satisfiability problems, invertible logic, etc., i.e., a wider range of objective problems applicable to solving, with high commercial and it is of high commercial and scientific application value.

Another aspect of the present disclosure provides a probabilistic bit circuit-based problem-solving optimization system 500 applied to implement the method described above, wherein a probabilistic bit circuit 300, a multiplexer MUX, an analog-to-digital converter ADC, a processor 510, a digital-to-analog converter DAC, and a multiplexer DEMUX are included. The probabilistic bit circuit is used to perform parallel probabilistic operations; the multiplexer MUX is used to output a plurality of signals read from the probabilistic probabilistic bit circuit for performing parallel probability operations; multiplexer MUX for outputting a plurality of signals read from the probabilistic bit circuit; analog-to-digital converter ADC for converting the plurality of signals output by the multiplexer to digital signals; processor 510 for processing the digital signals converted by the analog-to-digital converter to determine the column Hamiltonian and the flip probability values for determining the row probabilistic bits corresponding to the column Hamiltonian; digital-to-analog converter DAC for converting the flip probability values obtained by the processor to analog signals. The multiplexer DEMUX is used to follow up the analog signal converted by the digital-to-analog converter for the read and write operation of the probabilistic bits.

According to embodiments of the present disclosure, the probabilistic bit circuit 300 includes a plurality of probabilistic bit cells and a plurality of control lines, each of the plurality of probabilistic bit cells includes a spin-orbit torque magnetic tunnel junction to achieve probabilistically controllable magnetization flip when different electrical signals are applied to the plurality of control lines.

As can be seen, the above problem-solving optimization system 500 based on probabilistic bit circuit of the present disclosure embodiment may be implemented to run massively parallel annealing algorithms. where the probabilistic bit circuit is 300 used to perform probabilistic operations; a plurality of signals read from the probabilistic bit circuit 300 are selected by the multiplexer MUX to control certain signal outputs; the analog-to-digital converter ADC converts the analog signals output from the multiplexer MUX to digital signals; the processor 510 uses the read signals 300 from the probabilistic bit circuit to calculate Hamiltonian and selects the smallest column Hamiltonian in each iteration for calculating The processor uses the read signal in the probabilistic bit circuit to calculate the Hamiltonian and selects the smallest column Hamiltonian in each iteration to calculate the flip probability; the DAC converts the probability value calculated by the processor 510 from a digital signal to an analog signal; finally, the demultiplexer DEMUX sends the input signal to 300 the designated end of the probabilistic bit circuit to control the read and write of the probabilistic bits.

Specifically, the problem-solving optimization process implemented in the above problem-solving optimization system 500 based on the probabilistic bit circuit of the above embodiment of the present disclosure may be described with reference to the method described above and will not be repeated here. In addition, the technical details of the specific structural composition and role of the probabilistic bit circuit 300 in the problem-solving optimization system have been described in detail in the preceding paragraphs and will not be repeated here.

Thus far, embodiments of the present disclosure have been described in detail in connection with the accompanying drawings.

The specific embodiments described above further detail the purpose, technical solutions, and beneficial effects of the present disclosure. It should be understood that the above described are only specific embodiments of the present disclosure and are not intended to limit the present disclosure, and any modifications, equivalent replacements, improvements, etc. made within the spirit and principles of the present disclosure shall be included in the scope of protection of the present disclosure.

What is claimed is:

1. A method for optimizing problem-solving based on probabilistic bit circuits, comprising:
performing a modeling transformation on an objective problem to obtain a corresponding Hamiltonian relationship;
obtaining a column Hamiltonian of said probabilistic bit circuit based on said Hamiltonian relationship; and
performing parallel annealing iterations on multicolumn Hamiltonian based on row-flipping operations on said probabilistic bit circuits to obtain an updated probabilistic bit configuration, so as to achieve optimization of said problem.

2. The method according to the claim 1, wherein in said obtaining said column Hamiltonian of said probabilistic bit circuit based on said Hamiltonian relationship, comprising:
applying said Hamiltonian relationship to a plurality of columns of probabilistic bit cells of said probabilistic bit circuit, wherein said column Hamiltonian is a parallel annealed iterative branch of said Hamiltonian relationship.

3. The method according to the claim 1, wherein in said performing said modeling transformation on said objective problem to obtain said corresponding Hamiltonian relationship, comprising:
transforming said objective problem into an objective mathematical problem through modeling transformation;
mapping nodes of said objective mathematical problem to columns of probabilistic bit cells of said probabilistic bit circuit, and determining said column Hamiltonian based on a predetermined Hamiltonian relationship and a configuration of said columns of probabilistic bit cells; and
determining interdependencies between said probabilistic bit cells in column of probabilistic bit cells based on said Hamiltonian relationship.

4. The method according to claim 1, wherein in said performing parallel annealing iterations on said multicolumn Hamiltonian based on row-flipping operations on said probabilistic bit circuits to obtain an updated probabilistic bit configuration, comprising:
initializing an array of probabilistic bit circuits based on a row-flipping operation on said probabilistic bit circuits to read an initial state of probabilistic bit cell prior to the start of the annealing iteration;
determining a configuration corresponding to a column Hamiltonian with the smallest value among parallel column Hamiltonian; and
performing a parallel annealing iteration on said probabilistic bit circuit for said configuration.

5. The method according to claim 4, wherein in said initializing said array of probabilistic bit circuits based on a row-flipping operation on said probabilistic bit circuits, comprising:
performing a row flipping operation with 50% probability on said array of probabilistic bit circuits, wherein said array of probabilistic bit circuits is an array of probabilistic bit cells based on spin-orbit torque devices.

6. The method according to claim 4, wherein in said performing said parallel annealing iteration on said probabilistic bit circuit for said configuration, comprising:
determining a row writing probability corresponding to said configuration based on an interdependence between said configuration corresponding to the column Hamiltonian with the smallest value and a column of said probabilistic bit cell; and
sequentially performing, based on the row-flipping operation on said probabilistic bit circuit, a write operation to rows of probabilistic bit cells of said probabilistic bit circuit according to said row write probability, so as to iterate over a configuration of corresponding columns of probabilistic bit cells.

7. The method according to claim 6, further comprising:
reading an updated state of probabilistic bit cell in said array of the probabilistic bit circuits after each of said parallel annealing iterations; and
determining an updated column Hamiltonian based on said updated state of probabilistic bit cell.

8. The method according to the claim 7, wherein performing a parallel annealing iteration on said column Hamiltonian to determine probabilistic bit configuration, comprising:
determining a probabilistic bit configuration corresponding to said updated column Hamiltonian when a minimum value of said updated column Hamiltonian is either a fixed value or fluctuant in a very small range; and
performing parallel annealing iterations on said updated column Hamiltonian when the minimum value of said updated column Hamiltonian is neither a fixed value nor fluctuant in a very small range.

9. A system for optimizing problem-solving based on probabilistic bit circuits, which is applied to implement the method according to claim 1, comprising:
probabilistic bit circuits for parallel probabilistic operations;
a multiplexer for outputting a plurality of signals read from said probabilistic bit circuits;
an analog-to-digital converter for converting a plurality of signals from the output of said multiplexer to digital signals;
a processor for processing the digital signal converted by said analog-to-digital converter to determine a column Hamiltonian, and for determining a flipping probability value of said row probability bits corresponding to said column Hamiltonian;
a digital-to-analog converter for converting the flipping probability value obtained by said processor into an analog signal; and
a demultiplexer for following up the analog signal converted by said digital-to-analog converter for probabilistic bit reading and writing operations.

10. The system according to claim 9, wherein said probabilistic bit circuit comprises a plurality of probabilistic bit cells and a plurality of control lines, and each of said plurality of probabilistic bit cells comprising:
a spin-orbit torque magnetic tunnel junction for magnetization flipping when said plurality of control lines are applied with different voltages or currents.
